(19) United States
(12) Patent Application Publication
(10) Pub. No.: US 2025/0124771 A1
(43) Pub. Date: Apr. 17, 2025

(54) VIDEO DOORBELL WITH CHIME CONTROLLER

(71) Applicant: GENERAC POWER SYSTEMS, INC., Waukesha, WI (US)

(72) Inventors: Lucas Coelho CAVALHEIRO, Toronto (CA); Brent Patrick LAURENCE, Toronto (CA); John METSELAAR, Port Rowan (CA); Sajid MAHMOOD, Whitby (CA); Randy GLENN, Toronto (CA)

(21) Appl. No.: 18/916,374

(22) Filed: Oct. 15, 2024

Related U.S. Application Data
(60) Provisional application No. 63/544,309, filed on Oct. 16, 2023.

(51) Int. Cl. G08B 3/10; H04N 7/18

(52) U.S. Cl. CPC G08B 3/1016; H04N 7/183

(57) ABSTRACT

A video doorbell system operable to generate a chime sound, comprises a transformer, operable to convert a premise's power supply to a suitable. The video doorbell system further includes a video doorbell having a processor, a video camera and a wireless communication module. The video doorbell is electrically connected to the transformer by a two-wire interface. The processor within the video doorbell operable to generate a chime signal using power supplied from the two-wire interface when a doorbell button is depressed. The video doorbell system further includes a chime controller, electrically connected to the transformer and the video doorbell by the two-wire interface. The video doorbell system continues to provide sufficient power to the video doorbell from the transformer via the two-wire interface so as to be able to operate the processor, video camera and wireless communication module while the doorbell button is currently depressed.

### CROSS-REFERENCE TO RELATED APPLICATIONS

This application claims priority to U.S. provisional patent application No. 63/544,309, filed Oct. 16, 2023, the contents of which is incorporated herein by reference.

### FIELD

The present invention relates to doorbell systems. More specifically, the present invention relates to a video doorbell system having a video doorbell and a chime controller, powered over two wires. The two wires provide full power to the video doorbell and a return-signaling method to activate the indoor chime.

### BACKGROUND

A doorbell system 10 (as shown in FIG. 1) is a simple system, consisting of three major components: a transformer 12, an indoor chime 14 and a doorbell 16 having a doorbell button 18 (typically located outside the premise). The transformer 12 transforms a premise's 120 VAC to 16-24 AC. A two-wire interface (16-24 VAC) goes from the transformer 12 to the indoor chime 14 (typically located within the premise) and two wires go from the indoor chime 14 to the (outdoor) doorbell 16 to create the circuit as shown. When the doorbell button 18 on the doorbell 16 is depressed, the circuit is completed, and the indoor chime 14 is powered for the duration the doorbell button 18 is pressed in order to create a chime noise. When the doorbell button 18 is released, the circuit disconnects power to the indoor chime 14.

Video capabilities have been introduced to certain doorbell systems. Some video-capable doorbell systems are retrofitted on-premise using the pre-existing two-wire interface. While the doorbell system 10 is simple in design, installation and operation, adding video capabilities to the doorbell 16 using the existing two-wire interface is challenging. A video doorbell may require power at all times in order to power its central processing unit (CPU) and video camera. To activate the indoor chime 14, however, the two wires to a video-capable doorbell must commutate. Commutation disrupts the power going to the (video-capable) doorbell 16 for the duration the doorbell button 18 is pressed. In order to provide video capability, prior art doorbell systems using two-wire interfaces overcome this power disruption by having an internal rechargeable battery 20 located within the doorbell 16 to provide constant power to the video doorbell circuitry for the duration that the doorbell button 18 is pressed. When the doorbell button 18 is not pressed, a small amount of the power from the two-wire interface is used to recharge the battery 20, ready to provide backup power on the next press of doorbell button 18.

The use of the rechargeable battery 20 suffers from certain drawbacks, however. For example, the rechargeable battery 20 does not perform well in extreme cold temperatures. The capacity of the rechargeable battery 20 may also degrade over time, reducing the overall lifespan of the doorbell 16. Elevated temperatures within the housing of the doorbell 16 can further reduce the longevity of the rechargeable battery 20. The rechargeable battery 20 also adds bulk and cost to the system 10. In addition, given that the system 10 may ultimately be disposed of at the end of its operational lifespan, the presence of the rechargeable battery 20 is not environmentally friendly.

### SUMMARY

According to an embodiment of the invention, there is provided a video doorbell system operable to generate a chime sound, comprising a transformer, operable to convert a premise's power supply to a suitable voltage for the video doorbell system. The video doorbell system further includes a video doorbell, the video doorbell having at least a processor, a video camera operable to record video, and a wireless communication module operable to transmit video from the video camera across a remote network, the video doorbell being electrically connected to the transformer by a two-wire interface, the video doorbell further having a doorbell button, the processor within the video doorbell operable to generate a chime signal using power supplied from the two-wire interface when the doorbell button is depressed. The video doorbell system further includes a chime controller, electrically connected to the transformer and the video doorbell by the two-wire interface, the chime controller operable to receive the chime signal across at least one wire of the two-wire interface and activate a chime generator to generate a chime sound. The video doorbell system continues to provide sufficient power to the video doorbell from the transformer via the two-wire interface so as to be able to operate the processor, video camera and wireless communication module while the doorbell button is currently depressed.

### BRIEF DESCRIPTIONS OF THE DRAWINGS

Embodiments are described with reference to the following figures.

FIG. 1 shows a block diagram of a prior art doorbell system.

FIG. 2 shows a schematic representation of a premise containing a video doorbell system in accordance with an embodiment of the invention.

FIG. 3A shows an electrical block diagram of the video doorbell system shown in FIG. 2.

FIGS. 3B and 3C show schematic representation of the components of the video doorbell shown in FIG. 3A.

FIG. 4A shows a simulation chart of voltage over time between the video doorbell and a chime controller for the video doorbell system shown in FIGS. 3A-3C.

FIG. 4B shows a simulation chart of current over time between the video doorbell and the chime controller for the video doorbell system shown in FIGS. 3A-3C.

FIG. 5 shows an electrical block diagram of the video doorbell system shown in FIG. 3.

FIG. 6 shows a simulation of chart of voltage delays over time used within the video doorbell system shown in FIGS. 3A-3C.

FIG. 7 shows an electrical block diagram of signaling current within the video doorbell system shown in FIGS. 3A-3C.

FIG. 8 shows a simulation chart of current imbalance over time in the signaling current within the electrical block diagram shown in FIG. 7.

FIG. 9A shows an electrical block diagram of an incorrectly-wired video doorbell system shown in FIGS. 3A-3C.

FIG. 9B shows an electrical block diagram of a correctly-wired video doorbell system shown in FIG. 3.

FIG. 10 shows an electrical block diagram of another embodiment of the video doorbell system shown in FIG. 3.

FIG. 11 is a diagram of a battery chime adapter for use with the video doorbell system shown in FIGS. 3A-3C.

FIG. 12A and FIG. 12B illustrate power delivery to the video doorbell system of FIGS. 3A-3C when used with the battery chime adapter shown in FIG. 11.

### DETAILED DESCRIPTION

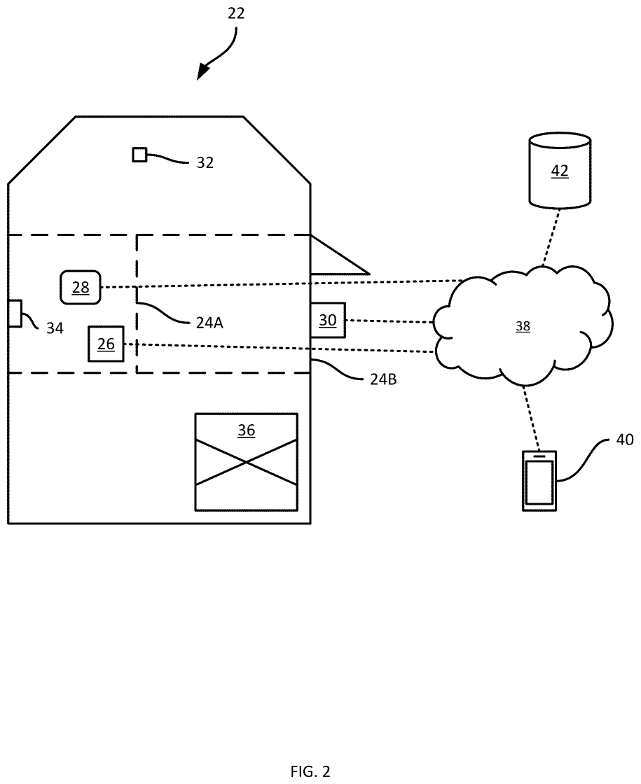

Referring now to FIG. 2, a premise is shown generally at 22. The premise 22 is typically a residential home, but in some embodiments, could also be a commercial building. The premise 22 is defined by and subdivided into multiple rooms (functionally, the kitchen, bedroom, hallway, etc.) by a plurality of walls 24. Some walls 24 are interior walls 24A (including both load-bearing and non-load bearing walls) and some are exterior walls 24B (thicker load-bearing walls, preferably well insulated). For simplicity, other features of the premise 22 such as doors, windows, stairs, etc. have been omitted from FIG. 2.

The premise 22 includes a plurality of smart devices, which can be considered either “hub” devices or “remote” devices. While not a strict delineation, hub devices are powered by the premise's 120 VAC electrical wiring (not depicted) and thus can have robust communication and computational abilities such as Wi-Fi and video streaming, whereas remote devices have constrained power, communication and computational abilities. As will be described in greater detail below, remote devices communicate with each other and/or hub devices locally within the premise 22, whereas hub devices are also operable to communicate with remote servers outside of the premise 22 via a network 38. In the present embodiment, hub devices include a smart thermostat 26, a smart camera 28 and a video doorbell (VDB) system 30. Remote devices in the present embodiment include remote sensors 32 and contact sensors 34. Other remote devices such as sirens and leak sensors (neither depicted) are also contemplated. Collectively, the hub and remote devices support a plurality of home automation applications.

The premise 22 further includes a HVAC system 36, which may include various heating and cooling systems furnaces, air conditioning systems, fans, heat pumps, humidification/dehumidification systems and the like. The HVAC system 36 is preferably controlled by the smart thermostat 26.

The network 38 can include a local area network (LAN) as well as connectivity to the Internet via a router (not depicted) or communication over a cellular network. The network 38 can also include mesh networks that facilitate communication between hub and remote user devices 40. The remote user devices 40 may communicate with the hub devices (such as the smart thermostat 26 or the video doorbell system 30) directly on the network 38 or indirectly via a remote server 42 across the Internet. The remote user devices 40 can include smart phones, smart watches, tablets as well as personal computers. The remote user devices 40 can control hub devices such as the smart thermostat 26 or view video content from the smart camera 28 or the video doorbell system 30.

The remote server 42 can act as an intermediary between the remote user device 40 and the hub device(s) within the premise 22, and route information and commands between the two. In addition, the remote server 42 may provide additional functionality (in the form of Software as Service, or SaaS), such as energy modeling, computationally intensive machine learning, video data storage, historical runtime reports, time and weather services, as well as third-party voice processing services such as the Amazon Alexa service. The remote server 42 can also be used to provide alerts and notifications to remote user devices 40 when they lose connection to the devices within the premise 22 (such as Wi-Fi being down) or when power is out in the premise 22.

As mentioned previously, the smart thermostat 26 is operable to act as a hub device. In the illustrated embodiment, the smart thermostat 26 is a wireless communicating thermostat, such as the ecobee3 lite or ecobee Smart Thermostat with Voice. Preferably, the smart thermostat 26 is equipped with wireless communication protocols such as Wi-Fi or Bluetooth to connect to the network 38 to provide for remote control of the smart thermostat 26 from the remote user device 40. The remote user devices 40 may communicate with the smart thermostat 26 directly on the network 38 or indirectly via the remote server 42 across the Internet.

The smart thermostat 26 is further in wireless communication with the one or more remote sensor(s) 32, which can provide different sensor readings such as occupancy, temperature, humidity, as well as CO or CO2 values to the smart thermostat 26 (via wireless protocols such as 802.11, Bluetooth, Zigbee HA or through a proprietary 900 MHz protocol). The smart thermostat 26 is operable to communicate with the remote sensor(s) 32 to provide occupancy and temperature averaging for its readings, and then prioritize temperature values in the rooms where occupancy is detected, and/or reduce the usage of the HVAC system 36 when no occupancy is detected within the premise 22 for an extended period of time. The smart thermostat 26 may also include its own occupancy sensor. Preferably, the smart thermostat 26 also includes a touchscreen, a microphone and speaker. In some embodiments, the touchscreen and speakers on the smart thermostat 26 can act as an output for video streams provided by the smart camera 28 or the video doorbell system 30, or for door chime signals generated by the video doorbell system 30.

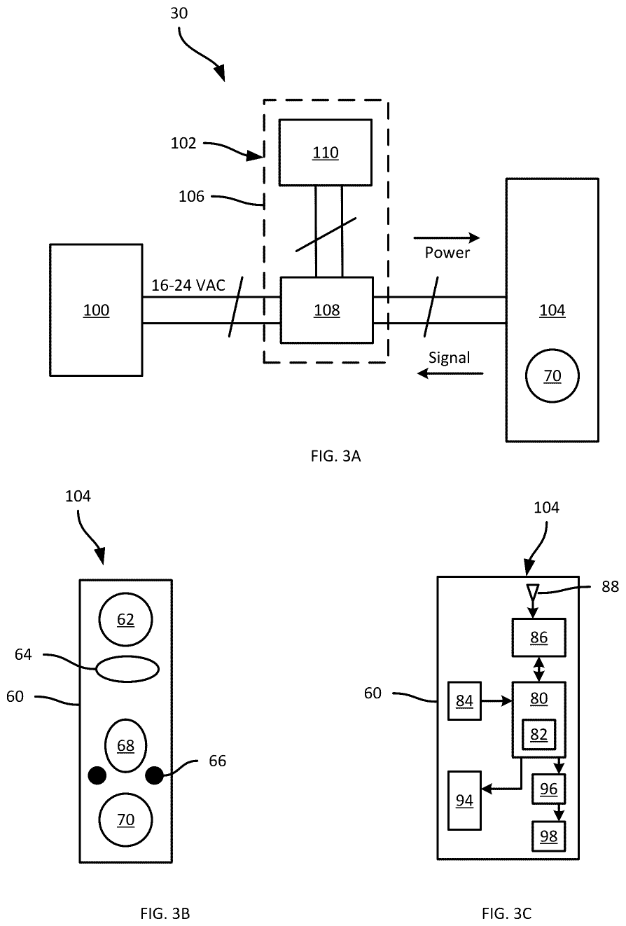

Referring now to FIGS. 3A, 3B and 3C, an embodiment of the invention is shown in greater detail. The video doorbell system 30 (FIG. 3A) includes a transformer 100 (located within the premise 22), a chime 102 (located within the premise 22) and a video doorbell 104 adapted to be installed on the outside of the premise 22 on an external wall. The transformer 100, the chime 102 and the video doorbell 104 are all connected by a standard two-wire interface.

Referring to FIGS. 3B and 3C, the hardware components of the video doorbell 104 are described in greater detail. External hardware components of the video doorbell 104 (FIG. 3B) include a weather-proof housing 60, a doorbell button 70, a video camera 62 and IR lighting 64 (typically all forward facing). The doorbell button 70 may be a plunger-style actuator operable to generate a door press signal in a processor 80 (described below). The video doorbell 104 may also include one or more microphone apertures 66 which allow sounds from outside the housing 60 to reach one or more internal microphones (described below) and a speaker grate 68 which allows sounds emitted from an internal speaker (discussed below) to exit the housing 60.

Internal components of the video doorbell 104 (FIG. 3C) include the processor 80, which can be a microprocessor, or any other suitable device as will occur to those of skill in the art. The video doorbell 104 further includes a memory 82, which can be non-volatile random access memory (RAM) and/or volatile RAM accessible by the processor 80. As will be apparent to those of skill in the art, the memory 82 can be integral with the processor 80, or can be separate discrete devices or components, as desired. The memory 82 can store one or more programs for execution by the processor 80 (such as a camera detection program and local video storage). The video doorbell 104 may also include at least one environmental sensor 84, which at a minimum is a temperature sensor operable to determine the current outdoor temperature, but can also include other environmental sensors, such as a humidity sensor.

A communication module 86 connected to the processor 80 to allow the processor 80 to communicate with the network 38 (e.g., the Internet) and/or with additional external sensors or computerized devices (not shown). Preferably, the communication module 86 is operable to connect to the desired data networks wirelessly, via an antenna 88, using at least one wireless communication protocol, such as Wi-Fi; Bluetooth; ZigBee; ZWave; Cellular Data, etc. The communication module 86 also allows the video doorbell 104 to communicate with Internet based services running on the remote server(s) 42 and with applications used remotely on the remote user devices 40. For example, a user remote from the video doorbell 104 may access an application executing on a smartphone (e.g., a remote user device 40) or personal computer to watch live streaming from the video camera 62.

The video doorbell 104 further includes a control block 94, which is adapted to connect to a standard two-wire interface found within the premise 22. The control block 94 provides the power supply and generates control signals across the two-wire interface within the video doorbell system 30, and is described in greater detail below.

The hardware in the video doorbell 104 further includes an audio output subsystem 96, which is operable in response to signals received from the processor 80, to output an amplified audio signal to a speaker 98 (which is arranged to output sound through the speaker grate 68). The audio output subsystem 96 can be a discrete device, or combination of suitable discrete devices, as desired and is preferably capable of outputting voice signals and/or simulated door chime sounds.

Referring back now to FIG. 3A, an embodiment of the invention is shown in greater detail. The transformer 100 is adapted to transform the premise 22's 120 VAC power supply (not depicted) into 16-24 VAC. The transformer 100 is connected to the chime 102 by a standard two-wire interface. The chime 102 includes a chassis 106 (located within the premise 22). Inside the chassis 106 is a chime controller 108 and a chime generator, which in the present embodiment is implemented as a chime solenoid 110. The chime controller 108 is connected to the video doorbell 104 via the standard two-wire interface. The transformer 100 feeds power to the chime controller 108 and to the chime solenoid 110 when the doorbell button 70 on the video doorbell 104 is pressed. The chime controller 108 provides connectivity to the chime solenoid 110. When signaling from the video doorbell 104 (described in greater detail below) is present (i.e., the doorbell button 70 is pressed), the chime solenoid 110 is energized for a period of time (e.g., one or two seconds), causing an armature to strike a sound plate (neither depicted) to create the chime sound.

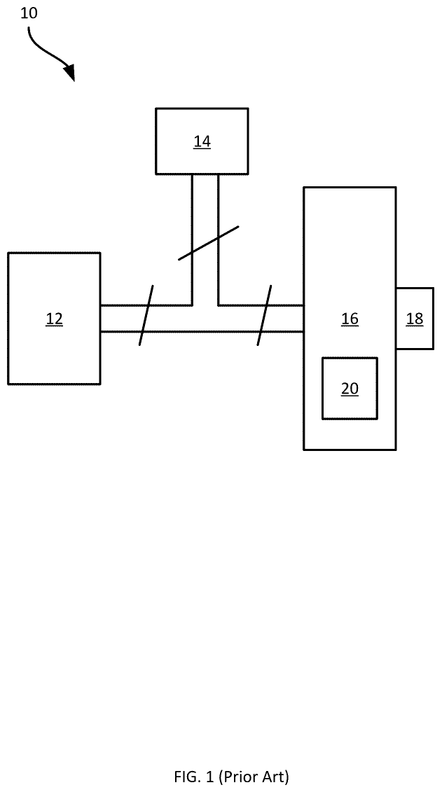

The chime controller 108 further provides connectivity to the video doorbell 104. Unlike the prior art system shown in FIG. 1, power is continuously provided to the video doorbell 104, regardless of whether the doorbell button 70 is pressed or not. Instead, the video doorbell 104 provides special signaling to the chime controller 108 when the doorbell button 70 is pressed. The special signaling is decoded by the chime controller 108, which causes the chime solenoid 110 to be briefly powered to create the chime sound (described above).

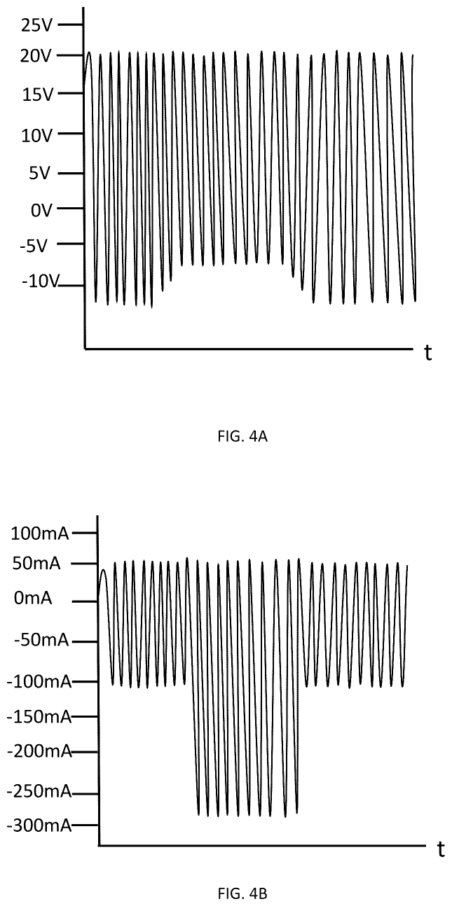

This special signaling (“call for chime”) comes in the form of sinking extra current on the negative excursions of the voltage sinusoid for the period of time (e.g., one or two seconds) when the doorbell button 70 is pressed. When the chime controller 108 detects this excessive current, its circuitry activates the chime solenoid 110. FIG. 4A shows a simulation of what happens on the two-wire interface between the video doorbell 104 and the chime controller 108 when the doorbell button 70 is pressed and there is a call for a chime (the waveform has been simplified for the purposes of illustration). The voltage is slightly reduced, but only on the negative sinusoid. The positive sinusoid remains intact. The video doorbell 104 sees this voltage as acceptable for its operation, although reduced in overall amplitude, and still carries AC voltage and current over the two-wire interface. FIG. 4B shows what the current consumption looks like on the two-wire interface during the signaling of a doorbell button 70 press which is a call for chime (waveform has been simplified for the purposes of illustration). The majority of negative current is being sunk at the time there is a call for chime. When there is no chime signaling, the current shown is the normal operating current of the video doorbell 104. The chime controller 108 detects this current envelope and activates the chime solenoid 110.

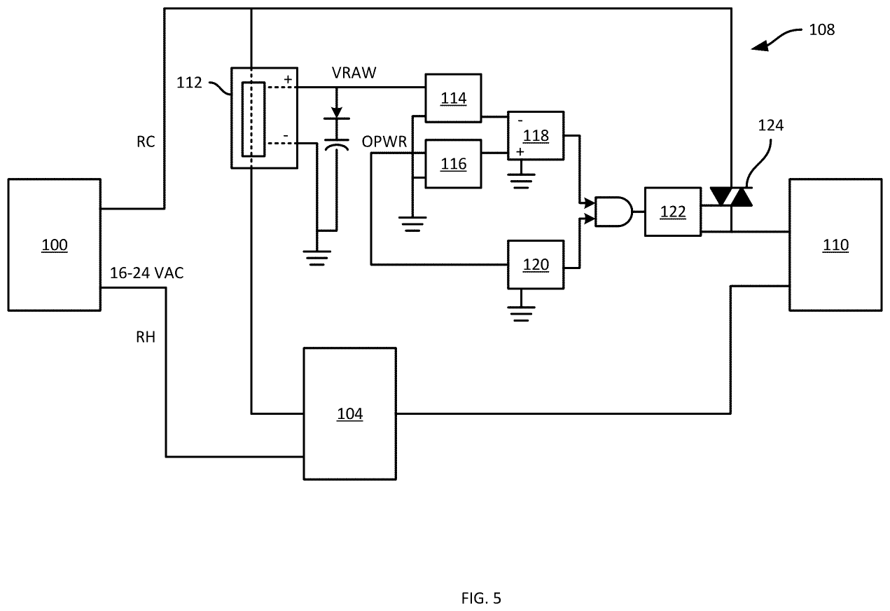

FIG. 5 illustrates a block diagram of the chime controller 108, showing the electrical processing from the transformer 100 to the chime solenoid 110. As mentioned previously, the transformer 100 transforms the premise 22's 120 VAC to 16-24 VAC. Two wires exit from transformer 100, RC and RH. RC passes through current to voltage (12V) detector 112, and then onward to the video doorbell 104. Current to voltage detector (12V) 112 consists of a full wave current rectifier and a filtered current to voltage converter. The output of current to voltage detector (12V) 112 is a voltage level that is representative of the current consumption of the video doorbell 104 with respect to a virtual ground. As the current to the video doorbell 104 increases or decreases, so does the voltage output (VRAW) of the current to voltage detector (12V) 112.

The full wave current rectifier in the current to voltage detector (12V) 112 passes current to the video doorbell 104 on the positive and negative current sinusoid. Half of the current sinusoid is fully passed to the video doorbell 104. The other half of the current sinusoid is processed to generate a local voltage (VRAW) with a virtual ground and then passed to the video doorbell 104. In this way the video doorbell 104 gets all the current it needs to operate. The voltage to the video doorbell 104, however, is slightly altered (as previously shown). The output, VRAW, of the voltage detector (12V) 112 is filtered into a power domain called OPWR which feeds the rest of the detection circuit.

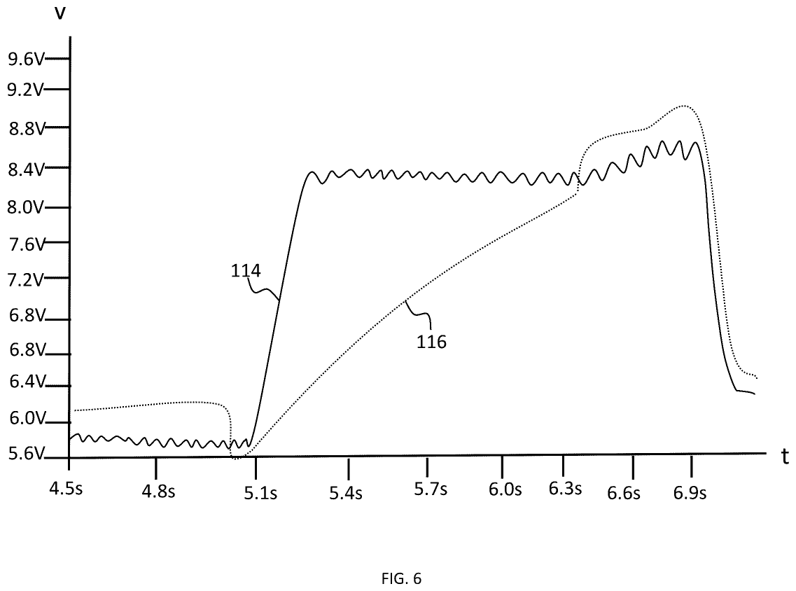

VRAW and OPWR feed into time delay circuits, the TD 114 and the TD 116, respectively, before going into a comparator 118. The output of TD 114 (VREF) goes into the negative terminal of the comparator 118. VREF has a faster time constant than the output of the TD 116 (VNODE). The difference in time delays is shown in the timing diagram of FIG. 6 (voltage waveforms have been simplified for the purposes of illustration). As can be seen, when there is a rapid change in current consumption, the output (VREF) of the TD 114 quickly rises to a representative voltage level. Meanwhile the output (VNODE) of the TD 116 slowly catches up to the voltage level at the TD 114. When the output of the TD 114 equals in voltage to the output of the TD 116, the hysteresis of the comparator 118 switches the output polarity. The time the voltage of the TD 114 remains above the voltage of the TD 116 is the duration the chime solenoid 110 is activated. In the illustration shown in FIG. 6, this is approximately 1.5 seconds (from about 5.1 s to about 6.4 s in the graph shown in FIG. 6). Elements of the TD 114 and the TD 116 may be adjusted to change the time the chime solenoid 110 is active (and thus, the length of the chime sound).

The time delay circuits, TD 114 and TD 116 are comprised of resistor and capacitors components (not individually depicted). At start-up, there is no initial voltage on the capacitors. As power is applied to the chime controller 108, the behavior of the TD 114 and the TD 116 is indeterminant and will cause the output of the comparator 118 to oscillate. This may cause the chime solenoid 110 to erratically activate as power stabilizes to the system and initializes all capacitor reference voltages. To mitigate erratic start-up behavior, a DWELL circuit 120 is provided that blocks an opto-triac circuit 122 from activation for a certain length of time while system voltages are stabilizing. Once the DWELL circuit 120 achieves the hold off time period, it allows the comparator 188 to control the opto-triac circuit 122. In this way any inadvertent chime solenoid 110 activations are blocked as power is connected to the system.

The opto-triac circuit 122 is an AC switch to turn the chime solenoid 110 on and off. Opto-triac circuit 122 is used to provide isolation to the OPWR subsystem while controlling the AC voltage. The opto-triac circuit 122 feeds into a power triac 124 to handle the heavy current demands of the chime solenoid 110.

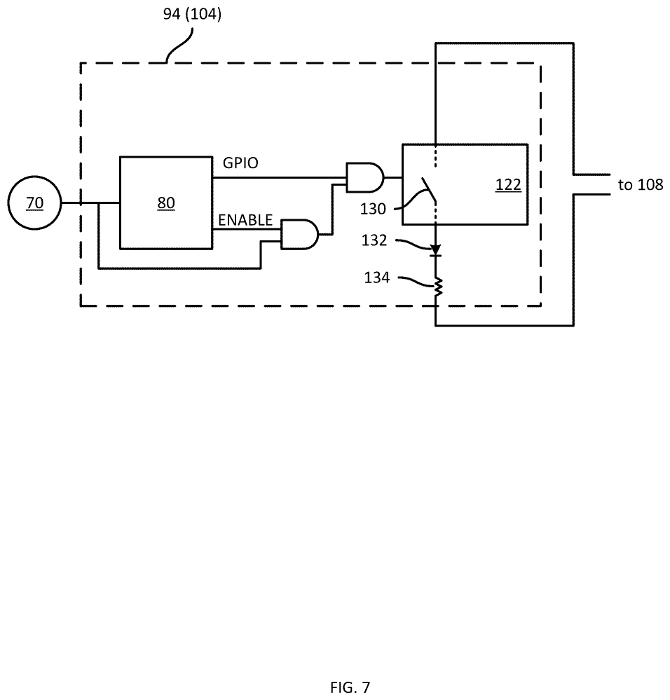

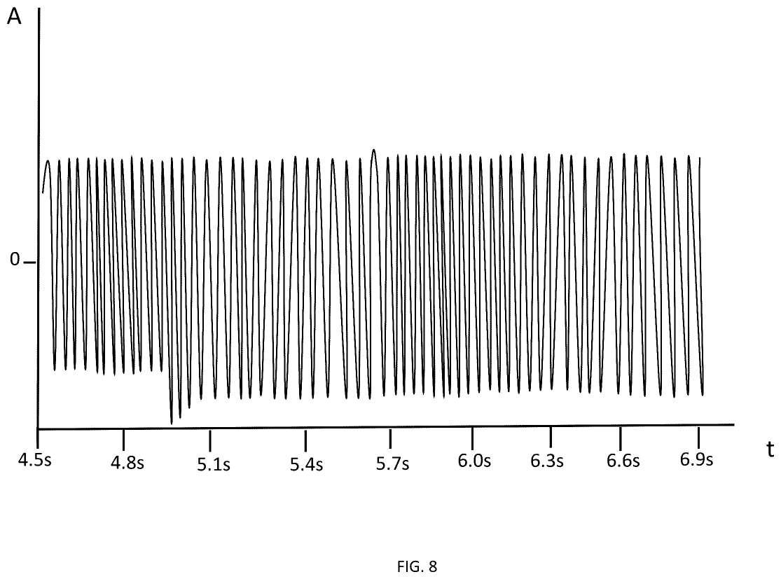

FIG. 7 is a block diagram of the control block 94 of the video doorbell 104, showing how the signaling current (call for chime) is created from a press of the doorbell button 70. The processor 80 monitors the doorbell button 70 press as shown on the left side of FIG. 7. After a doorbell button 70 press detection, the processor 80 debounces the doorbell button 70 signal and registers a valid doorbell button 70 press. A general input/output (GPIO) signal is then generated to activate a light emitting diode (LED) 130 in the opto-triac circuit 122. The opto-triac circuit 122 allows half the current sinusoid with the help of a diode 132 to sink current through a resistor 134. This current is supplemental to the current that the video doorbell 104 consumes during normal operation. While the opto-triac circuit 122 is commutating, a current imbalance is created for half the sinusoid for the duration the doorbell button 70 is pressed, i.e., half the sinusoid is larger in current than the other half of the sinusoid. FIG. 8 illustrates what is seen through simulation with the situation described above (waveform has been simplified for the purposes of illustration). In some examples, the doorbell button 70 can directly control the opto-triac circuit 122. If the processor 80 fails to boot, the video doorbell 104 can then still operate the chime 102.

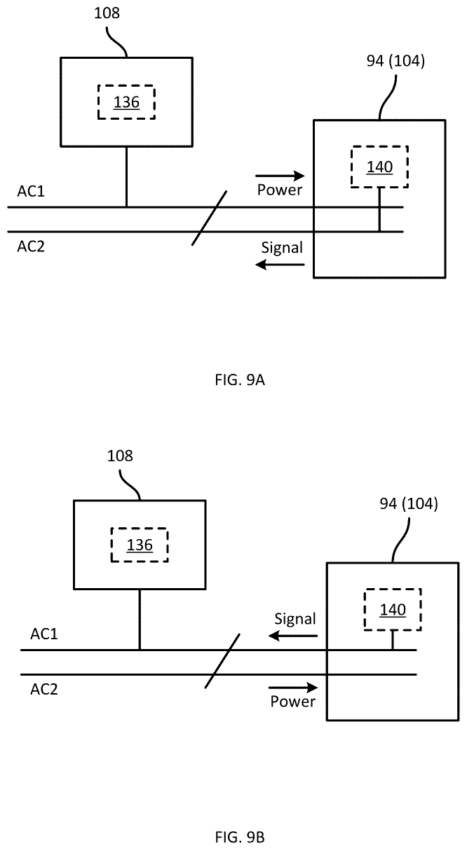

Referring now to FIGS. 9A and 9B, for the chime controller 108 to work properly, an inline detection circuit 136 located within the chime controller 108 must coincide with the same AC line that the video doorbell 104 uses to create the signaling current via a signaling current generator 140. This poses a potential problem with installation of the video doorbell 104, because there may not be marking on each of the two wires to indicate the proper polarity for connecting to the video doorbell 104, leaving an installer to rely on trial and error. FIG. 9A illustrates an incorrect installation, and FIG. 9B illustrates a correct installation.

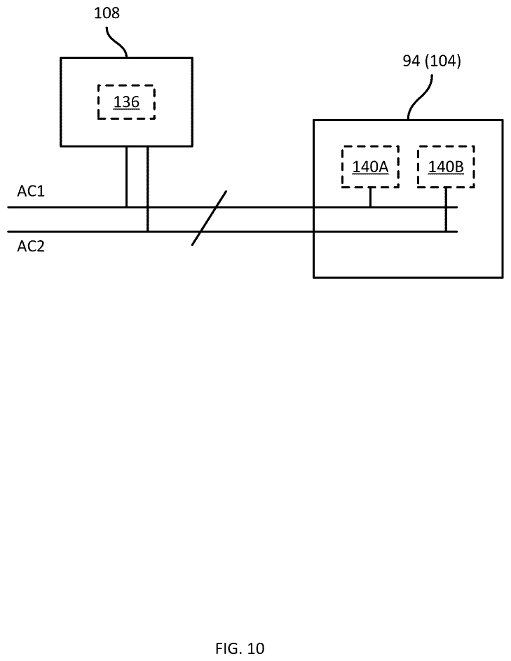

Referring now to FIG. 10, an embodiment of the invention is shown which overcomes the installation problem shown in FIGS. 9A and 9B, to make connectivity wiring-agnostic. In the embodiment shown in FIG. 10, the inline detection circuit 136 in the chime controller 108 connects to both wires AC1 and AC2. In addition, within the video doorbell 104, there are two signaling current generators, 140A and 140B to generate signaling current for each of the two wires AC1 and AC2. In this way, it does not matter how the two AC wires connect the chime 102 and the video doorbell 104. With a doorbell button 70 press, both signaling current generators 140A and 140B activate to generate the chime signal, and the detection circuit 136 will detect either.

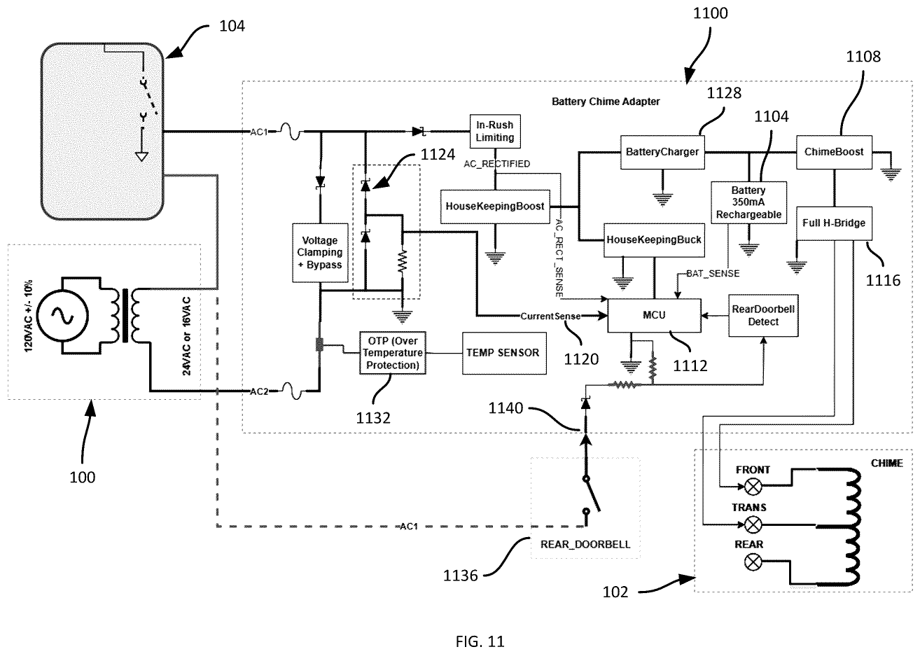

Referring now to FIG. 11, another embodiment of the invention is described. In the embodiment of FIG. 11, a battery chime adapter (BCA) 1100 is disposed between the transformer 100, chime 102, and VDB 104. The BCA 1100 allows the VDB 104 to actuate a mechanical or digital/electronic chime, such as the chime 102, without having to have both transformer wires accessible in the chime box, and without requiring a battery inside the VDB 104. The BCA 1100 may also mitigate brownout issues that could occur with transformers with low power ratings, such as 16 VAC 10VA transformers.

The BCA 1100 is connected in series with the transformer 100 and the VDB 104, and the in-home chime 102 is connected in parallel with the BCA 1100. The series connection allows the BCA 1100 to steal part of the energy being transferred from the transformer 100 to the VDB 104, and to receive messages from the VDB 104 via current pulses, e.g., to control actuation of the in-home chime 102.

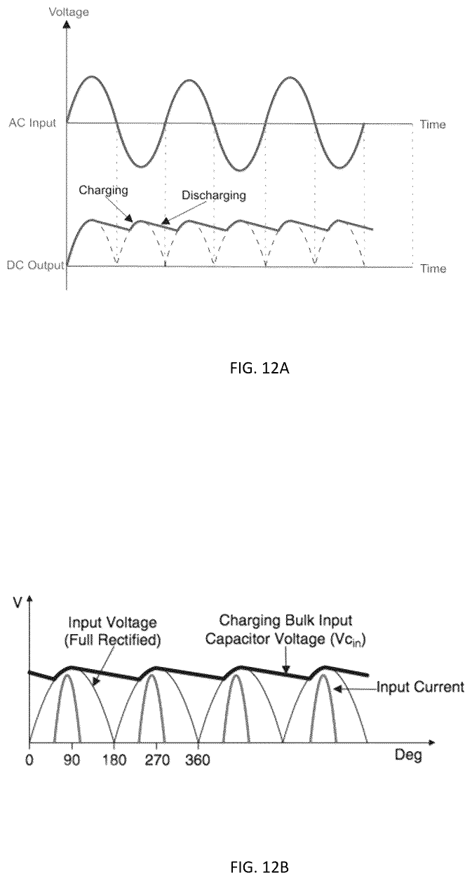

The VDB 104 power input comprises of a full-bridge rectifier with bulk capacitors to hold the charge, which means that there is only current flowing into the device when the transformer AC voltage is larger than the voltage held at the bulk capacitors. FIGS. 12A and 12B illustrate charging behavior at the VDB 104. Therefore, during the first and last 1 to 2 ms of each half-wave of the AC cycle, the VDB 104 does not make any use of the power made available by the transformer 100.

The BCA 1100 exploits this behavior to implement power-stealing (e.g., to trickle charge a battery 1104 which will be used to actuate the in-home chime 102) and communication without interfering with the power delivered to the VDB 104. The battery 1104 can be a lithium polymer (LiPo) single cell battery, e.g., charged at a rate of 10 mA by a charging circuit controlled by a microcontroller, discussed below.

Each of the AC phases can be referred to as a power or communication phase. Which phase is a power phase and which phase is a communication phase can be defined by the wiring configuration of the system. In the power phase of the transformer voltage, for the first and last 1 to 2 ms the BCA 1100 recharges its internal circuitry using a voltage regulation circuit that guarantees a specific voltage drop at its input. On the communication AC voltage phase, the BCA does not recharge its circuitry, and those same 1 to 2 ms time windows can be used by the VDB 104 to synchronize timing and transmit data to the BCA 1100 via current pulses. Because the recharge and communication functions are implemented near the start and end of each phase of the AC cycle, those functions do not disrupt power delivery to the VDB 104.

The power stealing functionality of the BCA 1100 is implemented using a unidirectional linear voltage regulator that will create a target voltage drop across the device and allow the internal circuitry to be charged. Once the voltage increases beyond the target voltage, the linear regulator allows current to pass through, keeping the voltage across the device around the target voltage. That means that the VDB 104 will see the voltage of the transformer minus the voltage drop across the BCA 1100, which in some cases can be detrimental to the performance of the VDB 104. When the power rating of the transformer 100 is low and the power consumed by the VDB 104 is large, for example while streaming video, playing audio and/or driving infrared LEDs for nighttime illumination, the decreased voltage from the BCA 1100 can compound with transformer output voltage droop from operating near saturation. This can cause the VDB 104 to brown-out. To mitigate such an outcome and allow for optimal power delivery to the VDB 104, a MOSFET was added in parallel with the linear regulator to allow the BCA 1100 to create a low-impedance path across itself and bypass the linear regulator, allowing the full voltage of the transformer 100 to be delivered to the VDB 104.

The MOSFET is timed based on the phase of the AC voltage cycle, and is tuned so that it will be off during the time that the VDB 104 does not need to sink current, and on during the time when the AC voltage is high enough to flow into the bulk capacitors of the VDB 104. Because both devices are wired in series, the VDB 104 will present a high impedance in series with the BCA 1100 when the transformer voltage is lower than the voltage at the input of its input bulk capacitors. To mitigate this issue, there is a transistor in parallel with the power input of the VDB 104 allowing it to create a low-impedance path so that the whole voltage of the transformer is applied to the BCA 1100, in a similar fashion to what was described above on the BCA side. In this way, the BCA 1100 does not steal power from the VDB 104 to charge the battery 1104 or maintain its housekeeping operation, and instead extracts power from the transformer 100 that is otherwise unused by the VDB 104. The BCA 1100 and VDB 104 synchronously time multiplex the power delivered from the transformer 100 by each using only an optimized portion of the phase for itself and ensuring a low-impedance path for the complement.

In summary, the power-stealing relies partially on a linear regulator in the BCA 1100 and on the coordinated activation of transistors on the BCA 1100 and the VDB 104 to allow each of the devices to either receive all the power at that moment or present a parallel low impedance so that the other device can use the power; only one of the bypass transistors is on at a time.

The chime driver assembly of the BCA 1100 includes of a boost converter, the battery 1104 (e.g., a lithium polymer battery), and several transistors for the chime actuation. Most mechanical chime solenoids are driven by the AC voltage of the transformer, but a DC voltage source will also work if the voltage is high enough and the source has low enough impedance. Electronic chimes require a more complicated actuation sequence, which a Housekeeping microcontroller unit (MCU) 1112 is able to perform.

Because the input voltage drop across the BCA 1100 is limited to about 5V, due to its power stealing architecture, in order to increase the input voltage to about 9V for mechanical chimes or 18V for digital/electronic chimes, a DC-DC boost converter 1108 (the Chime Boost Converter) is needed. The housekeeping MCU 1112 enables and disables the Chime Boost Converter 1108 depending on whether the in-home chime 102 is being activated or not.

The BCA 1100 can also include transistors configured in an H-Bridge topology 1116 which allow the Chime Boost Converter 1108 to apply the voltage across the in-home chime 102. Mechanical and Digital/Electronic chimes require different activation sequences on the transistors—the sequence to apply is communicated from the VDB 104 to the BCA 1100 at the time the in-home chime 102 is to be activated.

For a mechanical chime, the high side and low side transistors are used to apply a 9V voltage across the chime solenoid. The activation time is configurable from the VDB 104, and proper timing ensures a pleasant sound from the mechanical chime. Activation time ranges from 50 msec to 400 msec. Polarity is inverted on each chime cycle, to ensure that the solenoid does not become magnetized.

For an electronic chime, the Housekeeping MCU 1112 uses the same transistors to apply some power to the chime to initialize the unit. After 1 second of initialization by applying constant DC power, an AC waveform is simulated using the transistors, mimicking the unrectified AC power that normally activates an electronic chime. After this AC waveform, several seconds of DC power are applied to the electronic chime, during which time the electronic chime plays its chime sound. This period is configurable from the VDB 104 (ranging from 2 sec to 10 sec), allowing the user to control the duration of the chime sound. Polarity of the DC power is configurable, in case the digital/electronic chime only works in one polarity.

The BCA 1100 also implements a novel Low-Speed Power Line Communication (LSPLC) that allows low-cost implementation of power line communication. Unlike PLC systems that use a signal with much higher carrier frequency than the 50 or 60 Hz from the power line, the LCPLC sends one symbol for every AC cycle of the power line, making it a 60 bps (bits per second) data rate system for a 60 Hz power system. This approach permits a low-cost implementation, and reduces the potential for unintentional electromagnetic emissions.

As mentioned above in connection with the power stealing functionality, the power phase of the AC waveform is used to charge the housekeeping circuitry, and charge the battery 1104 if the battery voltage is lower than the re-charge threshold. On the communication phase of the AC sinusoid there is a current detection circuit 1120 that detects whether there is current running through the VDB 104 which helps in modulating data bits for message transmission. The housekeeping MCU 1112 monitors the level and timing of this current signal. Because the current monitor 1120 only works on one half of the AC cycle, by sending a current pulse from the VDB 104 at the start of that cycle, the housekeeping MCU 1112 can synchronize its timing to the current pulses triggered by the voltage zero-cross at the VDB 104. Furthermore, by measuring the pulse width of the current pulse and comparing with expected ranges, the housekeeping MCU 1112 determines if the signal it is seeing is proper communication from the VDB 104, or just noise.

The above implementation makes use of the short time before and after the voltage crosses 0 V because at that time the voltage has not become higher than the input bulk voltage on the VDB 104, and there is therefore little or no energy flowing into the VDB 104. If there is current detected during that period of time, the VDB 104 is intentionally activating its bypass transistor, which allows current to flow in parallel with its input. With this timing scheme, the BCA 1100 can interpret the current through the VDB 104 at that time as a bit. A current pulse after a long quiet period is assumed to be at the start of the AC cycle and aligned with a voltage zero-cross monitored by the VDB 104. It is used as a timing reference, and determines both when the bypass transistor is activated, and when the data is sampled. With a valid timing reference, current is measured roughly 1 ms before the next voltage zero-cross, in the window where the VDB 104 will not be drawing current on its own. An absence of current draw is interpreted as a logical 0 bit, and the presence of current draw is interpreted as a logical 1 bit. The current sense 1120 can be implemented in different ways, e.g., as a low-resistance shunt resistor with a high-gain amplifier enabled by the half-bridge rectification topology of the BCA 1100's circuitry power.

The communication protocol set out above implements a preamble, packet type, packet payload, and checksum at the end of the packet. These allow the VDB 104 and BCA 1100 to synchronize the start of the packet, transmit commands (chime type, chime activation parameters, etc.), and ensure that the received packet is valid. The MCU 1112 is responsible for interpreting the current sense signal, controlling the chime boost converter, controlling the switch to actuate the in-home chime and finally, controlling the bypass transistor to allow a low-impedance path to the VDB. Additionally, the MCU 1112 also controls charging of the battery 1104, as well as battery temperature monitoring.

To simplify installation, the VDB 104 is configured to determine how the BCA 1100 is wired into the circuit. For the power stealing function mentioned above to work, a current pulse is transmitted at the start and end of the power phase. However, in the communication phase, only the first pulse is sent unless data is being transmitted. Therefore, the VDB 104 is configured to determine which phase the BCA 1100 is being powered on, and which phase the BCA 1100 is listening for communications on. The chime adapter detection process set out below enables the VDB 104 to obtain this information.

As previously explained, to enable a charge or communication current pulse to go through the BCA 1100 at the start of each voltage zero-cross, the VDB 104 turns on a transistor at certain times. However, the low-impedance path across the VDB 104 relies on the impedance presented by the BCA 1100 to not overload the transformer 100 and the transistor. To prevent damage to the VDB 104 in case it has been installed without a BCA 1100 in series, the VDB 104 detects whether the BCA 1100 has been connected to the system prior to turning on its transistor.

The detection uses the different impedance presented by the chime controller 108 depending on the phase of the AC cycle. As explained in connection with the power stealing functionality above, there is a limited voltage drop of about 5 V across the BCA 1100 in one phase, and a voltage drop defined by two diodes 1124 on the other phase, which are part of, or associated with, the current sensing circuit 1120. Because of the difference in voltage drop across the BCA 1100, the input voltage ripple on the VDB 104's bulk capacitor peaks at two distinct levels every half cycle. If the ripple voltage peaks on both AC phases at the VDB 104's bulk capacitor are similar, that indicates the absence of a BCA 1100.

Substantially simultaneously with determining the presence of the BCA 1100, the VDB 104 can determine which phase the BCA 1100 is powered on, and which phase the BCA 1100 communicates on. The phase with higher voltage ripple is the phase with the lower voltage drop across the BCA 1100, which corresponds to the communication phase—this phase only has two diode drops in the BCA 1100. The phase with lower voltage ripple is the phase with higher voltage drop across the BCA 110, which corresponds to the power phase. Firmware in the VDB 104 can use this information to determine which phase to transmit power stealing pulses on, and which phase to transmit data on.

The system can include three levels of over-temperature safety. For example, a first level can be managed by a battery charger 1128 to cut off the battery 1104 if a temperature of the battery falls outside a predefined range, e.g., 0 C to 55 C. A second level of over temperature safety can be monitored by the MCU 1112, which can trigger the battery charger 1128 to disable charging at or above a predefined threshold (e.g., 40 C). The MCU 1112 can further disable chiming above a further threshold (e.g., 50 C). The MCU 1112 can further trip a fuse or otherwise disable the BCA 1100 at a further threshold (e.g., 55 C). Still further, a third level of over temperature safety can be provided by a circuit breaker fuse 1132 on the BCA 1100, e.g., if a temperature of the BCA 1100 reaches an upper threshold (e.g., 70° C.).

In some installations, a secondary/rear doorbell button 1136 may be connected to a second terminal on the in-home chime 102. To maintain compatibility with this type of installation, an additional input 1140 is provided on the BCA 1100. The MCU 1112 samples the voltage on this input, and uses a software filter to determine when the button 1136 has been pressed.

The VDB 104 can send periodic messages to the BCA 1100 informing the BCA 1100 of an action to take if the rear button 1136 is pressed, allowing the BCA 1100 to be configured for mechanical chime or digital/electronic chime without using non-volatile memory on the BCA 1100. When a rear button push is detected, the MCU 1112 of the BCA 1100 can read from the configured rear-chime action, and execute the command requested. This could be for mechanical chime, where duration and ramp-down time are specified, or for digital/electronic chime, where duration and some other actuation parameters are specified.

In order to distinguish between the front and rear chime sounds on a mechanical chime, two solenoids can be provided. The front solenoid can hit both the “ding” and “dong” chime bars, while the rear solenoid can hit only the “ding”. The BCA 1100 may be wired only to the front solenoid in some installations. However, the BCA 1100 can mimic the intended sound of the rear bell using a “ramp down” feature. In this mode, the BCA 1100 can fire the front solenoid at full strength for the “ding” sound, and then be gradually released by using a pulse-width modulated signal, to slowly reduce the current flowing through the solenoid over several seconds. This dampens the return of the solenoid, preventing the “dong” sound.

In some examples, two-way communication between the BCA 1100 and the VDB 104 can be implemented. Because the voltage ripple is asymmetrical every half-cycle on the VDB 104's bulk capacitor, as described above, that can also be leveraged for communication. The BCA 1100 has a bypass switch that is normally turned on around the peak of the AC voltage to create a parallel low-impedance path with the BCA 1100 removing the voltage drop created by its voltage regulator. Because that can be controlled by the BCA 110, by choosing to turn it on, or not, will create a higher, or lower ripple voltage peak at the bulk capacitor of the VDB 104.

The scope of the claims should not be limited by the embodiments set forth in the above examples, but should be given the broadest interpretation consistent with the description as a whole.

1. A video doorbell system operable to generate a chime sound, the video doorbell system comprising:
a transformer, operable to convert a premise's power supply to a suitable voltage for the video doorbell system;
a video doorbell, the video doorbell having at least a processor, a video camera operable to record video, and a wireless communication module operable to transmit video from the video camera across a remote network, the video doorbell being electrically connected to the transformer by a two-wire interface, the video doorbell further having a doorbell button, the processor within the video doorbell operable to generate a chime signal using power supplied from the two-wire interface when the doorbell button is depressed;
a chime controller, electrically connected to the transformer and the video doorbell by the two-wire interface, the chime controller operable to receive the chime signal across at least one wire of the two-wire interface and activate a chime generator to generate a chime sound; and
wherein the video doorbell system continues to provide sufficient power to the video doorbell from the transformer via the two-wire interface so as to be able to operate the processor, video camera and wireless communication module while the doorbell button is currently depressed.

2. The video doorbell system of claim 1, wherein the video doorbell includes at least one signal generator operable to generate the chime signal when the doorbell button is depressed, and the chime signal is transmitted across each wire of the two-wire interface.

3. The video doorbell system of claim 1, wherein the chime controller is operable to receive the chime signal across either wire of the two-wire interface.

4. The video doorbell system of claim 1, wherein the chime signal is created by reducing the voltage on one of the positive sinusoid and the negative sinusoid in the power supplied between the video doorbell and the chime controller across the two-wire interface.

5. The video doorbell system of claim 1, wherein the chime signal is created by sinking extra current on the negative excursions of the voltage sinusoid in the power supplied between the video doorbell and the chime controller across the two-wire interface when the doorbell button is pressed and the chime controller is operable to detect the extra current and activate the chime generator.

6. The video doorbell system of claim 1, wherein the chime generator is a chime solenoid.

7. A video doorbell, comprising:
a video camera;
a communication module operable to transmit video from the video camera;
a two-wire interface for electrically connecting the video doorbell to a transformer; and
a processor configured to:
generate a chime signal on the two-wire interface, using power supplied from the two-wire interface, when the doorbell button is depressed.

8. The video doorbell of claim 7, wherein the processor is configured to generate the chime signal by reducing a voltage on one of a positive sinusoid and a negative sinusoid of the power supplied across the two-wire interface.

9. The video doorbell of claim 8, wherein the processor is configured to generate the chime signal by sinking additional current on the negative sinusoid of the power supplied across the two-wire interface.

10. The video doorbell of claim 8, wherein the processor is configured to generate the chime signal without interrupting power delivery to the video doorbell over the two-wire interface.

11. The video doorbell of claim 7, wherein the processor is configured to transmit the chime signal on each wire of the two-wire interface.
